(19) United States
(12) Patent Application Publication
(10) Pub. No.: US 2006/0176975 A1
(43) Pub. Date: Aug. 10, 2006

(54) Method for modulator auto-IQ calibration

(76) Inventors: Yong-Hsiang Hsieh, Taoyuan City (TW); David Jan-Chia Chen, Taipei City (TW); Wei-Yi Hu, Yonghe City (TW); Shih-Ming Lin, Wandan Township (TW); Wen-Kai Li, Taipei City (TW); Chao-Liang Chen, Taipei City (TW)

Correspondence Address: LIN & ASSOCIATES INTELLECTUAL PROPERTY, P.O. BOX 2339, SARATOGA, CA, 95070-0339, US

(21) Appl. No.: 11/052,622

(22) Filed: Feb. 5, 2005

(51) Int. Cl. H04B 15/00

(52) U.S. Cl. 375/285

(57) ABSTRACT

A method of auto-I/Q calibration in modulator and demodulator, including DC cancellation, gain imbalance and phase error calibration is provided for implementation in a front-end circuit without the use of baseband processing signal. In modulator auto-I/Q calibration, the gain amplifier, peak detector, DC gain cell and comparator and auto-I/Q calibration control logic form a calibration loop between modulator output and input buffer. The DC test vectors for their corresponding calibrations are applied to modulator to determine I/Q mismatch. In the calibration loop, the peak detector convert the carrier leakage, differential signal power level caused by the I/Q path gain mismatch and by the local quadrature mismatch into DC signal power level. The comparator is used to measure the DC different on peak deter output under different input test vector. According to the comparing result, the auto-I/Q calibration control logic can get a set of appropriate control code to adjust the inphase and quadrature path gain, phase of LO buffer to minimize the resulting mismatch between corresponding carrier signals presented at modulator output. In demodulator auto-I/Q calibration, a baseband signal generated by dividing a reference clock is utilized as test tone to sense which path has less gain between I/Q for gain imbalance calibration. A down-conversion mixer, low pass filter, unity gain buffer and comparator form the phase calibration loop in demodulator. The mixer mixes the I/Q signal to result a DC offset used to determine which path has phase error when there is quadrature mismatch, and then the extra delay generated by delay cell is added on it.

### FIELD OF THE INVENTION

The present invention generally relates to radio frequency frond-end integrated circuit, and in particular more to a method and circuitry for modulator and demodulator auto-I/Q calibration.

### BACKGROUND OF THE INVENTION

The inphase/quadrature signal processing, vastly utilized in present communication transceivers, has a problem of mismatching the amplitude (gain) and phase of the inphase and the quadrature branch, called I/Q imbalance, which is one of the severe performance bottlenecks in transceivers. The gain and phase mismatch between inphase signal and quadrature signal degrades the signal-to-noise ratio (SNR), which, in turn, leads to the increase of the bit error rate. It is, therefore, necessary to establish an auto calibration mechanism in the transceiver in order to reduce the gain imbalance and phase error contributed by I/Q path.

### SUMMARY OF THE INVENTION

The present invention has been made to overcome three classes of distortion which degrade SNR performance of modulator and demodulator in a transceiver, including DC offset, gain imbalance of I/Q path and phase imbalance of I/Q path. The primary object of the present invention is to provide a method for modulator and demodulator auto-I/Q calibration to reduce the bit error rate. Instead of using the baseband signal processing techniques, the implementation of modulator and demodulator auto-I/Q calibration in the frond-end can alleviate the imbalance gain and phase caused by the mismatch of circuitry layout of I/Q path.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a flowchart of a method for modulator and demodulator auto-I/Q calibration of the present invention;

FIG. 2 shows a block diagram of an embodiment of a circuit for performing modulator DC offset cancellation, modulator I/Q gain imbalance calibration, and modulator phase error calibration of the present invention;

FIG. 3 shows a flowchart of the modulator DC offset cancellation procedure according to the present invention;

FIG. 4 shows a flowchart of the modulator auto-I/Q gain imbalance calibration procedure according to the present invention;

FIG. 5 shows a flowchart of the modulator auto-I/Q phase error calibration procedure according to the present invention;

FIG. 6 shows a block diagram of an embodiment of a demodulator auto-I/Q gain imbalance calibration circuit of the present invention.

FIG. 7 shows a flowchart of the demodulator auto-I/Q gain imbalance calibration procedure according to the present invention;

FIG. 8 shows a block diagram of an embodiment of demodulator auto-I/Q phase error calibration according to the present invention;

FIG. 9 shows the algorithm for demodulator auto-I/Q phase error calibration according to the present invention.

### DETAILED DESCRIPTION OF THE PREFERRED EMBODIMENTS

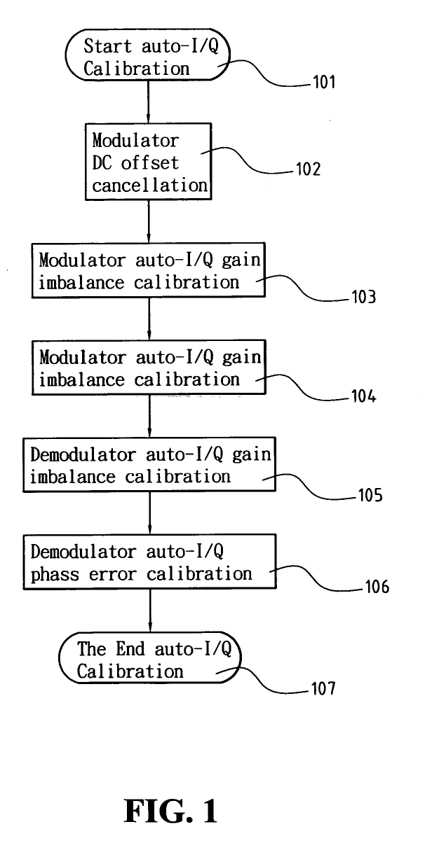

FIG. 1 shows a flowchart of a method for modulator and demodulator auto-I/Q calibration of the present invention. The auto-I/Q calibration method of the present invention includes DC offset cancellation, gain imbalance calibration and phase error calibration performed by modulator and demodulator. The method starts with step 101. Step 102 is to perform DC offset cancellation on the modulator, followed by step 103, performing auto-I/Q gain imbalance calibration on the modulator, and step 104, performing auto-I/Q phase error calibration on the modulator. After calibrating the modulator, the method continues with step 105, demodulator auto-I/Q gain imbalance calibration, and step 106, demodulator auto-I/Q phase error calibration. The method ends with step 107. It is worth noting that the DC offset cancellation should be processed first due to the DC test vector utilized in the subsequent calibrations.

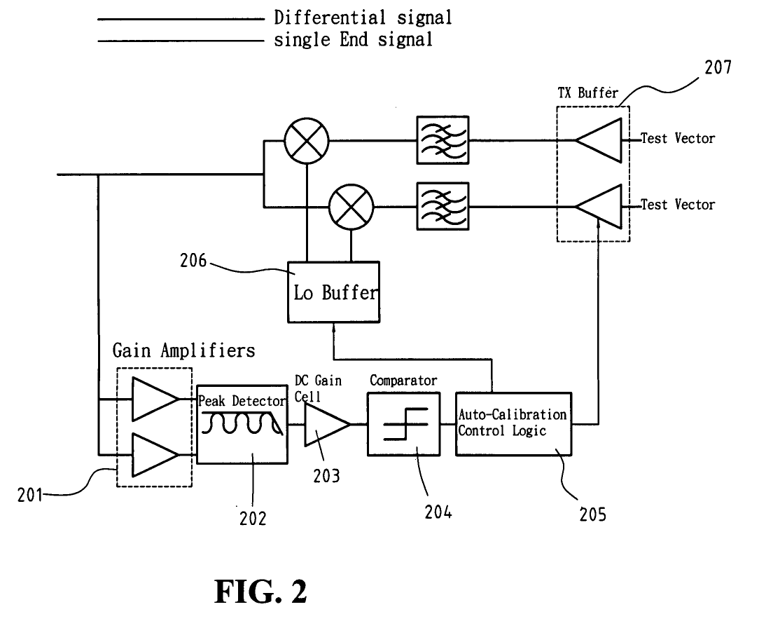

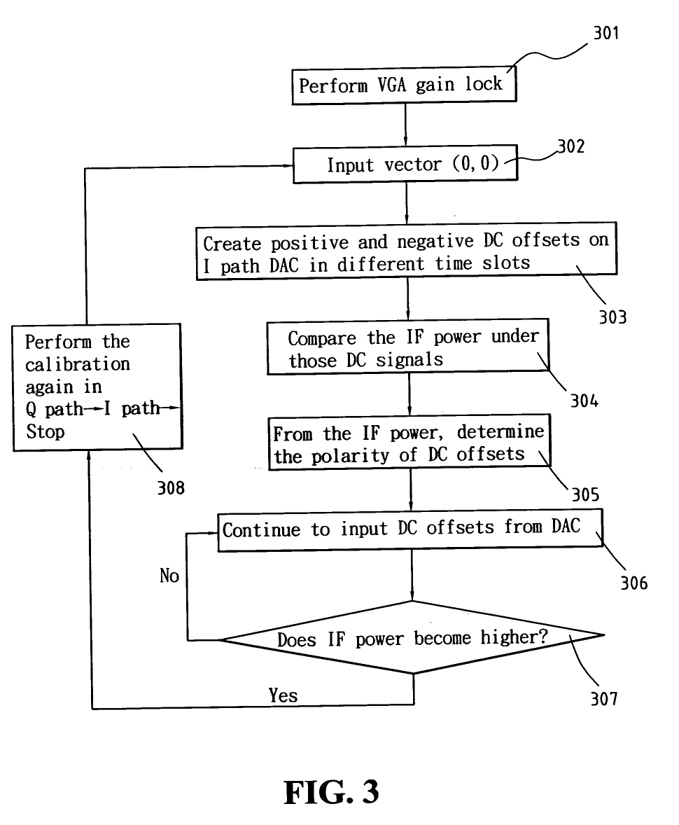

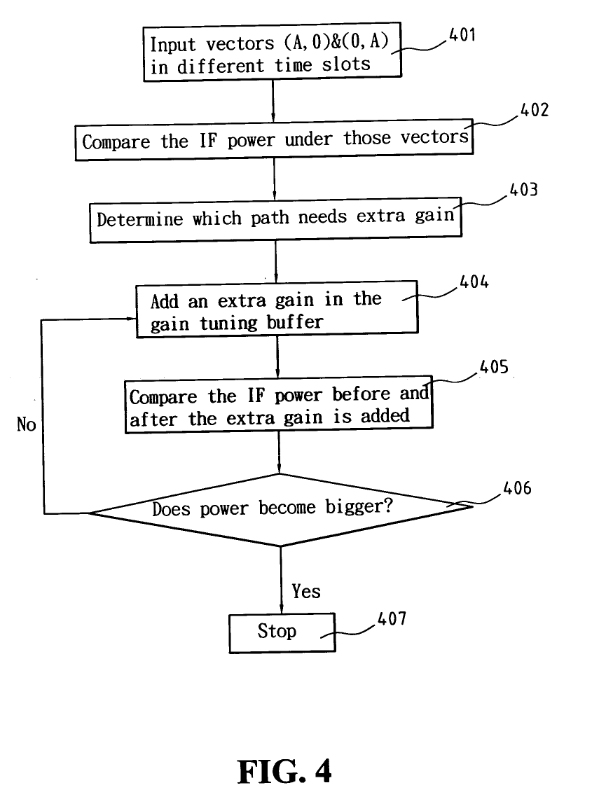

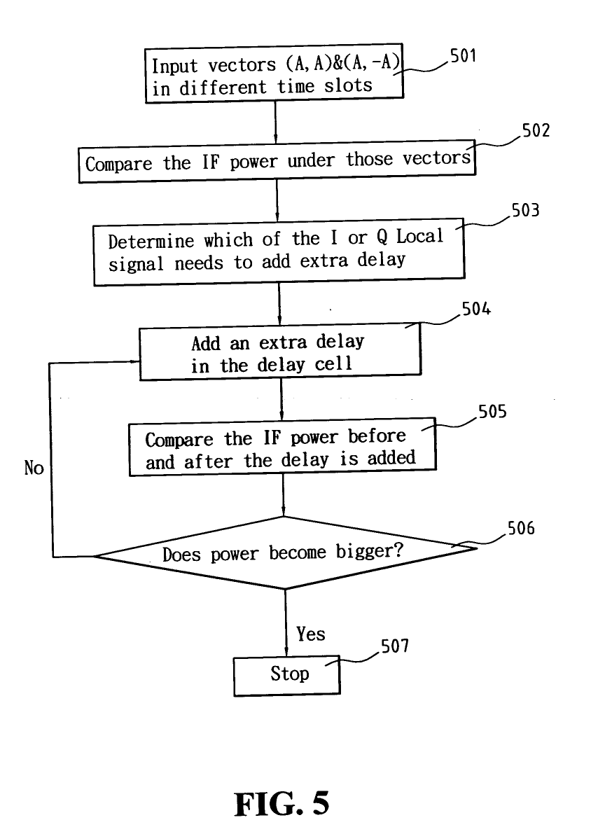

FIG. 2 shows a block diagram of an embodiment of a circuit that can be used to perform modulator DC offset cancellation, modulator I/Q gain imbalance calibration, and modulator quadrature error calibration of the present invention. FIG. 3, FIG. 4 and FIG. 5 show the flowcharts of the modulator DC offset cancellation procedure, modulator auto-I/Q gain imbalance calibration procedure, and modulator auto-Il/Q phase error calibration procedure of the present invention, respectively.

The following description refers to FIG. 2 and FIG. 3, respectively. As shown in FIG. 2, the circuit architecture of a calibration loop includes two gain amplifiers 201, a peak detector 202, a DC gain cell 203, a comparator 204, and auto-I/Q calibration control logic 205. The DC offset cancellation should be performed before all the calibrations. For DC offset cancellation, the differential Q path input is shorted, and the positive I path connect to the common mode DC signal. A small DC signal is applied to the negative I path inputs to generate a local leakage signal at modulator output. Peak detector 202 converts the local leakage power into a DC signal. Sample and hold comparator 204 is used to hold the DC level signal at the output of DC gain cell 203 and compare this DC level with the coming one obtained by exchanging the input setting. In order to relax the resolution requirement of comparator 204, fixed gain amplifiers 201 are placed before peak detector 202, and DC gain cell 203 is added between peak detector 202 and comparator 204. Depending on the polarity of the output of comparator 204, auto-I/Q calibration control logic 206 will generate an appropriate control code to adjust the DAC in modulator input buffer, and generate an extra DC signal to compensate the path with negative DC offset. If the DC offset measured by comparator 204 has the same polarity with the extra DC signal, the carrier leakage will increase. On the other hand, if the DC offset has the opposite polarity of the extra DC signal, the carrier leakage will decrease. The same steps are applied to the Q path and the cancellation procedure will be executed again. FIG. 3 shows a flow chart of the DC offset cancellation procedure, including step 301 performing VGA gain lock, step 302 inputting vector (0,0), step 303 creating positive and negative DC offsets on I path DAC in different time slots, step 304 comparing the IF power under those DC signals, step 305 determining the polarity of DC offsets from the IF power, step 306 continuing to input DC offsets from DAC, step 307 checking whether IF power become higher, and if not, repeating step 306; otherwise, taking step 308 to perform the calibration in Q path, back to I path again and then finish the DC offset cancellation procedure.

The following description refers to FIG. 2 and FIG. 4, respectively. The embodiment shown in FIG. 2 can also perform modulator gain imbalance calibration procedure shown in FIG. 4. As shown in FIG. 2, two test vectors are measured to determine which test vector will give a higher output power at modulator output by peak detector 202 and sample and hold comparator 204. To determine the polarity of gain imbalance between I/Q, a DC test vector of (A,0) is applied to modulator input buffer 207. A different signal power level caused by gain mismatch on the I/Q path will be present at the modulator output. Peak detector 202 converts the different power level at modulator output into a DC signal power level, which will be held by comparator 204. Another DC test vector of (0,A) is applied to the modulator input buffer, comparator 204 will compare both of the DC signals, which are amplified through I and Q path respectively that may have different gain due to mismatch. The output of comparator 204 gives the information on which path of the modulator has less gain. According to the information, auto-I/Q calibration control logic 205 will generate a set of appropriate logic codes to adjust the I and Q path gain to minimize the resulting mismatch between corresponding carrier signals present at the modulator output. The compensated gain is generated by a gain-controlled DAC in modulator input buffer and added on the path with smaller gain. The DC signal with compensated gain on the smaller gain path will be constantly compared with the one on the higher gain path until comparator 204 changes its output polarity, and then the gain calibration calibration procedure stops, and the I/Q gain imbalance becomes balanced. The aforementioned description of the I/Q gain imbalance calibration procedure is shown as a flowchart in FIG. 4. The procedure includes step 401 inputting vectors (A,0) and (0,A) in different time slots, step 402 comparing the IF power under those vectors, step 403 determining which path needing extra gain, step 404 adding an extra gain in the gain tuning buffer, step 405 comparing the IF power before and after adding the extra gain; and step 406 determining whether power becoming bigger, and if so, the procure stops; otherwise repeating step 404 and continuing.

The following description refers to FIG. 2 and FIG. 5, respectively. The embodiment shown in FIG. 2 can also perform modulator phase error calibration procedure shown in FIG. 5. As shown in FIG. 2, a DC test vector (A,A) is applied to the modulator buffer input 207, and then another DC test vector (A, −A) is applied. A different signal power level caused by the local quadrature mismatch will appear at the modulator output. According to the comparing result from comparator 204, auto-I/Q calibration control logic 205 will generate a set of appropriate control codes to adjust the I and Q path phase of LO buffer 206 by adding an extra delay to minimize the resulting phase error between corresponding carrier signals presented at the modulator output. The calibration procedure stops and the phase error can be alleviated within to one degree when the polarity of comparator 204 output changes. The aforementioned description of the phase error calibration procedure is shown as a flowchart in FIG. 5. The procedure includes step 501 inputting vectors (AA) and (A, −A) in different time slots, step 502 comparing the IF power under those vectors, step 503 determining which path needing an extra delay, step 404 adding an extra delay in the delay cell, step 505 comparing the IF power before and after adding the extra delay; and step 506 determining whether power becoming bigger; and if so, the procedure stops; otherwise, repeating step 504 and continuing.

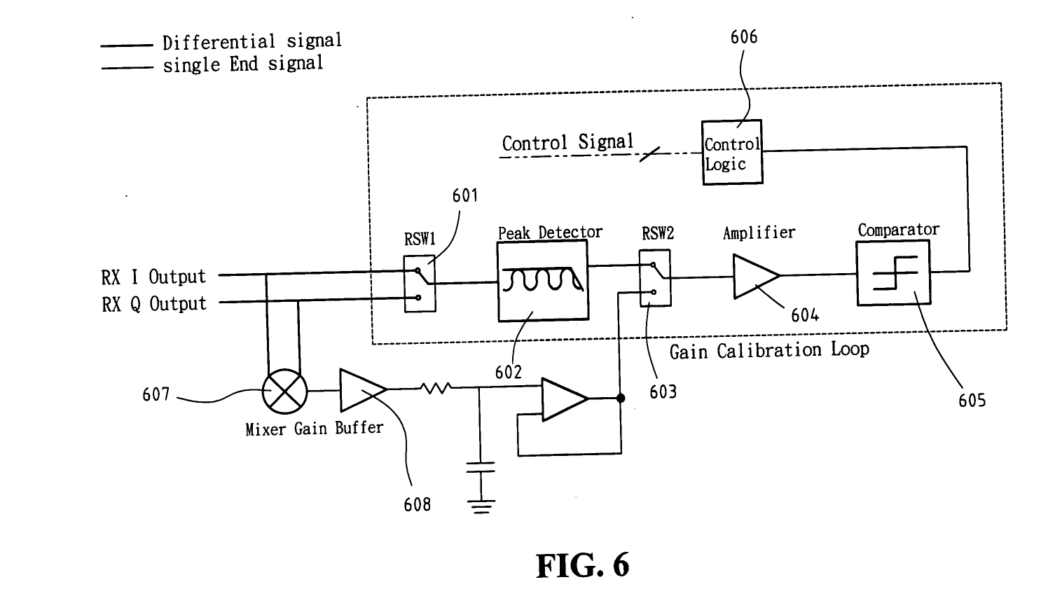

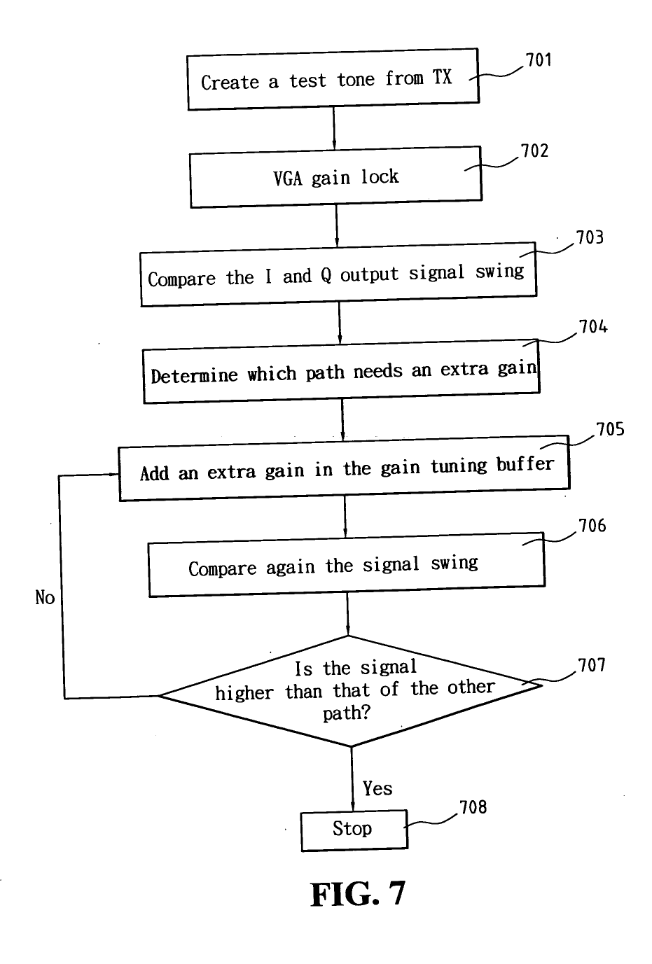

FIG. 6 shows a block diagram of an embodiment of a demodulator auto-I/Q gain imbalance calibration circuit of the present invention, and FIG. 7 shows a flowchart of the demodulator auto-I/Q gain imbalance calibration procedure. The gain imbalance calibration circuit includes a first switch RSW1 601, a peak detector 602, a second switch RSW2 603, an amplifier 604, a comparator 605, and a control logic 606. A mixer 607 and a gain buffer 608 are not useed in this gain imbalance calibration procedure. In demodulator gain imbalance calibration, a baseband test signal tone, which is generated by dividing a reference clock, inputs to the modulator IF up-conversion mixer to up-converted to an IF signal. In the calibration procedure, the test signal is first sent to detect which path has less gain. As shown in FIG. 6, first switch RSW1 601 is switched to connect the RX I differential output to the input of peak detector 602 and second switch RSW2 603 turns to peak detector 602 to make a way for gain calibration loop. Peak detector 602 converts the differential signal to a DC level, being held by sample and hold comparator 605. Then, first switch RSW1 601 turns to the RX Q differential output. The Q path signal is also converted to a DC level by peak detector 602 and will compare with the previous I signal holding by comparator 605 to detect which path has less gain. Comparator 605 output polarity will generate a set of appropriate control codes for auto-I/Q control logic 606 to increase gain of the gain tuning buffer on the path with less gain for compensation of gain imbalance. FIG. 7 shows the flowchart of the demodulator auto-I/Q gain imbalance calibration procedure, including step 701 creating a test tone from TX, step 702 performing VGA gain lock, step 703, comparing the I and Q output signal swing, step 704 determining which path needing an extra gain, step 705 adding an extra gain in the gain tuning buffer, step 706 comparing again the signal swing, and step 707 determining whether the signal being higher than that of the other path; and if so, the procedure stops; otherwise, return to step 705 and continue.

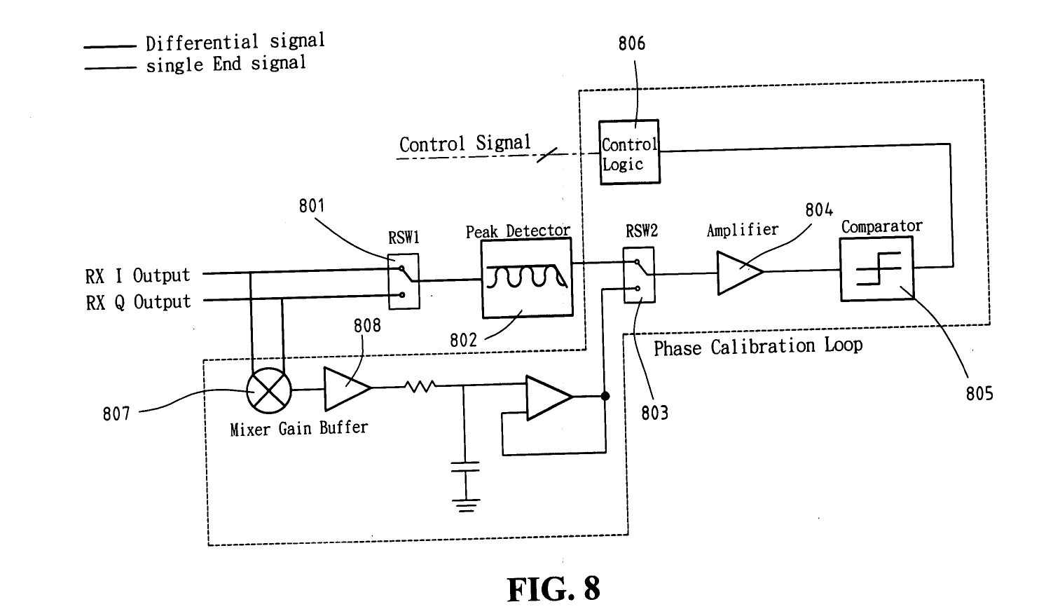

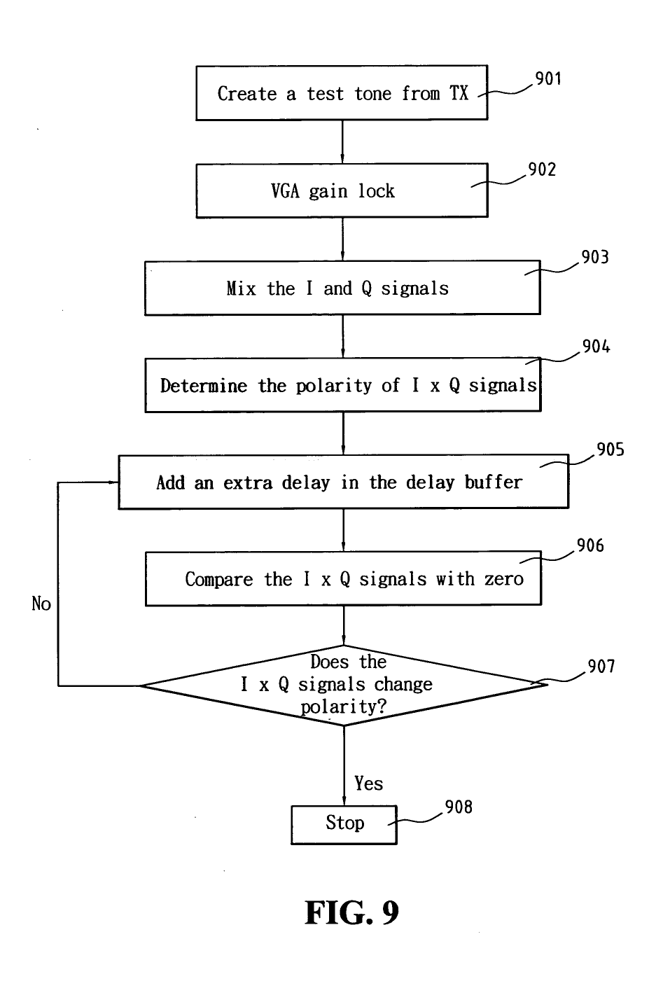

FIG. 8 shows a block diagram of an embodiment of a demodulator auto-I/Q phase error calibration circuit of the present invention, and FIG. 9 shows a flowchart of the demodulator auto-I/Q phase error calibration procedure. As shown in FIG. 8, the calibration loop for phase error includes an down-conversion mixer 807 with input of RX I differential output and LO signal of RX Q differential output, a low pass filter, a unity gain buffer 808, a switch RSW2 803, an amplifier 804, a comparator 805 and a control logic 806. A switch RSW1 801 and a peak detector 802 are not used in this procedure. As in the previous calibration procedure, the first step of the phase error calibration procedure is to detect the phase error between I path and Q path to compensate. Therefore, the DC operation point at output of mixer 807 without any input is held by comparator 805, and then mixer 807 is given the input from RX I differential output RX Q differential output to mix I and Q signal. After I/Q mixing, the I/Q phase error will generate a DC offset at output of mixer 807. By comparing the DC level resulted from I/Q mixing with DC operation point held previously, the phase error can be known. According to the output of comparator 805, auto I/Q control logic 806 will generate a set of appropriate code for adjusting phase. The compensation will process through the use of delay cell on I/Q path. FIG. 9 shows a flowchart of the aforementioned phase error calibration procedure, including step 901 creating a test tone from TX, step 902 performing VGA gain lock, step 903, mixing the I and Q signals, step 904 determining the polarity of mixed I/Q signals, step 905 adding an extra delay in the delay buffer, step 906 comparing again the mixed signal I/Q with zero, and step 907 determining whether the signal changing polarity; and if so, the procedure stops; otherwise, return to step 905 and continue.

Although the present invention has been described with reference to the preferred embodiments, it will be understood that the invention is not limited to the details described thereof. Various substitutions and modifications have been suggested in the foregoing description, and occurs will occur to those of ordinary skill in the art. Therefore, all such substitutions and modifications are intended to be embraced within the scope of the invention as defined in the appended claims.

What is claimed is:

1. A method for modulator and demodulator auto-I/Q calibration, comprising the following steps:
(a) a modulator DC offset cancellation step;
(b) a modulator gain imbalance calibration step;
(c) a modulator phase error calibration step;
(d) a demodulator gain imbalance calibration step; and
(e) a demodulator phase error calibration step.

2. The method as claimed in claim 1, wherein said modulator DC offset cancellation step (a) further comprises the following steps:
(a1) performing VGA gain lock;
(a2) inputting vector (0,0);
(a3) creating a positive and a negative DC offsets on I path DAC in different time slots;
(a4) comparing the IF power under said DC signals;
(a5) determining the polarity of said DC offsets from the IF power,
(a6) continuing to input DC offsets from DAC;
(a7) checking whether IF power become higher, and if not, repeating step (a6);
(a8) performing the calibration in Q path; and
(a9) performing the calibration in I path.

3. The method as claimed in claim 1, wherein said modulator gain imbalance calibration step (b) further comprises the following steps:
(b1) inputting vectors (A,0) and (0,A) in different time slots;
(b2) comparing the IF power under said vectors;
(b3) determining which path needing extra gain;
(b4) adding an extra gain in gain tuning buffer;
(b5) comparing the IF power before and after adding said extra gain; and
(b6) determining whether power becoming bigger; and if not, repeating (b4) and continuing.

4. The method as claimed in claim 1, wherein said modulator phase error calibration step (c) further comprises the following steps:
(c1) inputting vectors (AA) and (A, −A) in different time slots;
(c2) comparing the IF power under said vectors;
(c3) determining which path needing an extra delay;
(c4) adding an extra delay in a delay cell;
(c5) comparing the IF power before and after adding said extra delay; and
(c6) determining whether power becoming bigger; and if not, repeating step (b4) and continuing.

5. The method as claimed in claim 1, wherein said demodulator gain imbalance calibration step (d) further comprises the following steps:
(d1) creating a test tone from TX;
(d2) performing VGA gain lock;
(d3) comparing I and Q output signal swing;
(d4) determining which path needing an extra gain;
(d5) adding an extra gain in gain tuning buffer;
(d6) comparing again the signal swing; and
(d7) determining whether the signal being higher than that of the other path; and if note, returning to step (d5) and continuing.

6. The method as claimed in claim 1, wherein said demodulator phase error calibration step (e) further comprises the following steps:
(e1) creating a test tone from I/X;
(e2) performing VGA gain lock
(e3) mixing the I and Q signals;
(e4) determining the polarity of mixed I/Q signals;
(e5) adding an extra delay in the delay buffer,
(e6) comparing again said mixed signal I/Q with zero; and
(e7) determining whether said signal changing polarity; and if not, returning to step (e5) and continuing.

7. An apparatus for auto-I/Q calibration of modulator and demodulator, comprising a first calibration device used in said modulator and a second calibration device used in said demodulator, said first calibration device further comprising:
two gain amplifiers;
a peak detector;
a DC gain cell;
a comparator; and
an auto-calibration control circuit;
a local delay cell;
said second calibration device further comprising:
a first switch;
a peak detector,
a second switch;
an amplifier,
a comparator,
a control logic;
a mixer, and
a gain buffer.
